(19) United States
(12) Patent Application Publication
(10) Pub. No.: US 2007/0066758 A1
(43) Pub. Date: Mar. 22, 2007

(54) Modified filler-containing polypropylene resins

(76) Inventors: Christopher P. McArdle, Gananoque (CA); Karlheinz Hausmann, Auvernier (CH)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/522,574

(22) Filed: Sep. 18, 2006

Related U.S. Application Data
(60) Provisional application No. 60/717,650, filed on Sep. 16, 2005.

(51) Int. Cl. C08L 23/04

(52) U.S. Cl. 525/240

(57) ABSTRACT

Disclosed is a method for preparing filled polypropylene compositions comprising mixing a dicarboxylic acid anhydride-grafted polypropylene resin and an ethylene/vinyl acetate copolymer or an ethylene/alkyl (meth)acrylate copolymer with polypropylene, filler and optionally an elastomer. Also disclosed are compositions comprising a dicarboxylic acid anhydride-grafted polypropylene resin and an ethylene/vinyl acetate copolymer or an ethylene/alkyl (meth)acrylate copolymer that can be used as compatibilizers or coupling agents allowing preparation of polypropylene compositions filled with, for example, glass fibers. The glass-filled resin composition exhibits excellent finishing properties, such as adhesion, coating properties, and printability, as well as improved rigidity and thermal properties.

The application claims priority to U.S. provisional application No. 60/717,650, filed Sep. 16, 2005, the entire disclosure of which is incorporated herein by reference.

This invention relates to a method for preparing a modified polypropylene composition, which can be filled with inorganic fillers to provide an engineering polymer for shaped articles.

### BACKGROUND OF THE INVENTION

In recent years polypropylene-based composites have been developed to replace metals and many types of engineering thermoplastics in high-performance applications. The significant growth in polypropylene use is attributed to a combination of many factors including a good balance in physical and chemical properties. Because of appropriate melt rheology and thermal behavior, polypropylene-based compositions can be processed by a wide variety of techniques ranging from injection molding to sheet extrusion and thermoforming, on a variety of different equipment. Polypropylene also has wide design flexibility and simplicity of recycling. Additionally, since polypropylene has the lowest density of common commodity plastics (at about 0.90 g/cm³), polypropylene composites provide good mechanical properties at reduced weight per volume. Its excellent thermal stability and chemical and environmental inertness add to its attractiveness as a material of construction.

The mechanical properties of polypropylene can be modified to suit a wide variety of end-use applications. Various fillers and reinforcements, such as glass fiber, mica, talc, and calcium carbonate, can be added to polypropylene resin to attain cost-effective composite mechanical properties. Fibrous materials tend to increase both mechanical and thermal properties, such as tensile strength, flexural modulus, heat deflection temperature, creep resistance and sometimes impact strength. Fillers such as talc and calcium carbonate may be used as extenders to produce a less-costly material; also, some improvements in stiffness and impact strength may be obtained with these materials.

Most fillers and reinforcements are polar, but polypropylene is nonpolar. As a result, poor adhesion between the filler surface and the polymer matrix prevents necessary wetout by the molten polymer to break up clumps of aggregates of filler particles. This incompatibility leads to poor dispersion and insufficient reinforcement with accompanying poor mechanical properties.

There are a number of things that can be done to overcome incompatibility problems. One frequently used approach is to modify the chemistry of the polypropylene by attaching polar groups to the molecular backbone. For example, polypropylene can be modified by grafting with an unsaturated carboxylic acid or an anhydride thereof, e.g., acrylic acid, maleic anhydride, etc., in the presence of an initiator, e.g., organic peroxides. According to these processes, the grafting is accompanied by decomposition of polypropylene with the peroxide so that the amount of the unsaturated carboxylic acid or the anhydride thereof to be incorporated is limited. Mechanical properties of the modified polypropylene can be impaired due to molecular weight reduction of polypropylene. Grafted polypropylene can be used as is, but is more typically blended with unmodified polypropylene as a bulk polymer to provide a modified polypropylene blend. Grafted polypropylene is used as a chemical coupling agent in filled and reinforced polypropylene composites. The coupling agents provide enhanced interfacial adhesion between the filler and polymer matrix that provide effective stress transfer from the relatively weak polymer matrix to filler reinforcement to give improved composite mechanical and thermal properties.

For example, U.S. Pat. Nos. 4,764,546 and 4,868,226 and European Patent Application EP311723 describe compositions comprising (a) a polypropylene resin; (b) a modified polypropylene resin containing an unsaturated dicarboxylic acid anhydride repeating unit; (c) an ethylene copolymer comprising an alkyl acrylate or alkyl methacrylate repeating unit and an unsaturated dicarboxylic acid anhydride repeating unit; and (d) a filler.

Applications for filled and reinforced polypropylene composites have broadened markedly in recent years with particular growth in the automotive, appliance and hand tool markets. For example, in the automotive industry, many components have been converted from heavier materials, such as metals, to polypropylene composites to reduce the weight of vehicles. Numerous interior trim (e.g. doors, quarter panels, consoles) parts and exterior parts (e.g. bumper fascia, rocker panels) now make use of the excellent performance and appearance of polypropylene composites.

Therefore, it is desirable to develop improved polypropylene composites.

### SUMMARY OF THE INVENTION

An object of this invention is the preparation of filled polypropylene compositions having improved properties.

Accordingly, this invention provides a method for preparing a filled polypropylene composition comprising mixing, for example by melt-blending,

(a) a modified polypropylene resin containing from 0.1 to 3 mol % of an unsaturated dicarboxylic acid anhydride repeating unit;

(b) at least one ethylene copolymer derived from an ethylene repeating unit and an ester repeating unit selected from vinyl acetate comonomer, alkyl acrylate comonomers and alkyl methacrylate comonomers having from 1 to 6 carbon atoms in the alkyl moiety thereof;

(c) a polypropylene resin

(d) a filler; and optionally

(e) at least one elastomeric copolymer.

Of note is the method wherein (a) and (b) are mixed prior to mixing with (c), (d) and optionally (e).

Another object of this invention is to provide a modifier composition that can be used as a coupling agent and/or compatibilizer for preparing a modified polypropylene composition, including filled and/or reinforced polypropylene composites that comprise the modifier composition.

Accordingly, this invention provides a composition comprising

(a) a modified polypropylene resin containing from 0.1 to 3 mol % of an unsaturated dicarboxylic acid anhydride repeating unit;

(b) at least one ethylene copolymer derived from an ethylene repeating unit and an ester repeating unit selected from vinyl acetate comonomer, alkyl acrylate comonomers and alkyl methacrylate comonomers having from 1 to 6 carbon atoms in the alkyl moiety thereof; optionally

(c) a polypropylene resin; optionally

(d) a filler; and optionally

(e) at least one elastomeric copolymer.

Compositions consisting essentially of components (a) and (b) can be prepared wherein component (b) is present in up to 95 weight %, preferably 50 weight % or above, of the total weight of (a) and (b) to provide a composition for use in modifying polypropylene. These compositions can be added to a polypropylene resin [component (c)] in up to about 15% of the total weight of (a), (b), (c) and optionally (e) to provide modified polypropylene compositions. The modified polypropylene compositions can be mixed with fillers to provide filled compositions comprising (a), (b), (c), (d) and optionally (e), wherein the combination of (a) and (b) is present in up to about 5 weight %, alternatively from about 1 to about 5 weight % of the total composition, and the filler (d) is present in up to about 70 weight % of the total composition.

This invention also provides articles prepared from the compositions described above.

### DETAILED DESCRIPTION OF THE INVENTION

All references disclosed herein are incorporated by reference.

“Copolymer” means polymers containing two or more different monomers.

Thermoplastic compositions are polymeric materials that can flow when heated under pressure. Melt index (MI) is the mass rate of flow of a polymer through a specified capillary under controlled conditions of temperature and pressure. Melt indices reported herein are determined according to ASTM 1238 at 190° C. using a 2160 g weight, with values of MI reported in grams/10 minutes. Melt flow rates (MFR) are measured in a similar way, but at different temperatures depending on the melting point of the material.

Glass fiber filled polypropylene compositions (PP/GF) are engineering polymers that can be used to make, for example, injection molded parts. Such compositions can be filled with from 10 to 40 weight % glass fibers. To improve the physical properties of the product a small amount (for example, less than 10 weight %) of a compatibilizer/coupling agent can be added to the composition during the compounding process, and in some cases additional modifiers may be added to improve the impact performance of the final product. For these applications coupling agents have included maleic-anhydride grafted polypropylene (MAH-g-PP) copolymers.

To date, understanding of the use of MAH-g-PP as coupling agents in PP/GF systems directly relates the level of graft modification to final product performance wherein higher amounts of anhydride moieties (typically arising from a higher graft level) lead to better physical properties for the overall composition (for broader discussion of MAH-g-PP coupling agents, see “Handbook of Polypropylene and Polypropylene Composites”, Ed: H. G. Karian).

However, we have now prepared modifier compositions based on blending MAH-g-PP with ethylene copolymers such as ethylene/vinyl acetate copolymers (EVA) and ethylene/alkyl (meth)acrylate copolymers for use as coupling agents. Based on the prior understanding, we expected that the performance of the modifier prepared by blending of a copolymer with a MAH-g-PP having high anhydride graft levels would be comparable to that of a neat MAH-g-PP with low graft levels. Surprisingly, we have found that the performance of the mixed products is almost equivalent to the neat highly grafted material. The expected drop in performance with reduced anhydride content was not observed, even when using a modifier blend having as little as 20 weight % (or less) MAH-g-PP. Even more surprisingly, we have found that preparing equivalent mixed products using a copolymer with low/medium anhydride graft levels also delivered performance comparable to that of a neat copolymer with high anhydride graft levels. In contrast, use of either an ethylene/alkyl (meth)acrylate copolymer or a maleic anhydride-grafted ethylene/alkyl (meth)acrylate copolymer alone delivered no improvement as a coupling agent. In summary, using a combination of a MAH-g-PP and an ethylene/alkyl (meth)acrylate copolymer (or EVA copolymer) provides a modified polypropylene composition with performance that would not be expected given the prior technical understanding of these systems.

Polypropylene

Polypropylene (PP) resins that can be used in the present invention as component (c) include homopolymers, random copolymers, block copolymers and terpolymers of propylene, and mixtures thereof. Copolymers of propylene include copolymers of propylene with other olefins wherein the olefin has from two to ten carbon atoms such as ethylene, 1-butene, 2-butene and the various pentene isomers, etc. and preferably copolymers of propylene with ethylene. Terpolymers of propylene include copolymers of propylene with ethylene and one other olefin. Random copolymers, also known as statistical copolymers, are polymers in which the propylene and the comonomer(s) are randomly distributed throughout the polymeric chain in ratios corresponding to the feed ratio of the propylene to the comonomer(s). Block copolymers are made up of chain segments consisting of propylene homopolymer and of chain segments consisting of, for example, random copolymers of propylene and ethylene. The term “polypropylene” when used herein is used generically to refer to any or all of the polymers comprising propylene described above.

Polypropylene homopolymers or random copolymers can be manufactured by any known process. For example, polypropylene polymers can be prepared in the presence of Ziegler-Natta catalyst systems, based on organometallic compounds and on solids containing titanium trichloride.

Block copolymers can be manufactured similarly, except that propylene is generally first polymerized by itself in a first stage and propylene and additional comonomers such as ethylene are then polymerized, in a second stage, in the presence of the polymer obtained during the first. Each of these stages can be carried out, for example, in suspension in a hydrocarbon diluent, in suspension in liquid propylene, or else in gaseous phase, continuously or noncontinuously, in the same reactor or in separate reactors.

Additional information relating to block copolymers and to their manufacture may be found particularly in chapters 4.4 and 4.7 of the work “Block Copolymers” edited by D. C. Allport and W. H. Janes, published by Applied Science Publishers Ltd in 1973, which are incorporated by reference in the present description.

The polypropylene resin usually has a melt flow rate (MFR), measured according to ASTM D 1238 at 230° C., ranging from 0.5 to 100, and preferably from 1 to 50, g/10 min.

Anhydride-Modified Polypropylene

The modified polypropylene resins that can be used as component (a) comprise a polypropylene copolymer having from 0.1 to 3 mol % of an unsaturated dicarboxylic acid anhydride repeating unit. Monomers providing the unsaturated dicarboxylic acid anhydride repeating unit include maleic anhydride, citraconic anhydride, itaconic anhydride, tetrahydrophthalic anhydride, etc., with maleic anhydride being preferred. Functional equivalents of maleic anhydride include maleic acid and/or its salts, maleic acid mono- or diesters, itaconic acid, fumaric acid and fumaric acid monoesters.

The modified polypropylene resin can be obtained by known techniques, such as a process in which a polypropylene resin is dissolved in an organic solvent with an unsaturated dicarboxylic acid anhydride and a radical generator, followed by heating with stirring, and a process in which all the components are fed to an extruder to provide a maleic-anhydride grafted polypropylene (MAH-g-PP). These graft copolymers are available commercially from E. I. du Pont de Nemours and Company, Wilmington, Del. (DuPont) under the FUSABOND® brand name.

Ethylene/Vinyl Acetate Copolymers

The composition of this invention may comprise at least one ethylene/vinyl acetate copolymer (an EVA copolymer) as component (b). Ethylene/vinyl acetate dipolymers includes copolymers derived from the copolymerization of ethylene and vinyl acetate. Ethylene/vinyl acetate terpolymers include copolymers derived from the copolymerization of ethylene, vinyl acetate and an additional comonomer.

The relative amount of the vinyl acetate comonomer incorporated into ethylene/vinyl acetate copolymers can, in principle, vary broadly from a few weight percent up to as high as 45 weight percent of the total copolymer or even higher. The relative amount of the vinyl acetate present can be viewed as establishing how and to what degree the resulting ethylene copolymer is to be viewed as a polar polymeric constituent in the blended composition.

The ethylene/vinyl acetate copolymer is not limited, but preferably has a vinyl acetate unit content of from 6 to 40% by weight, especially from 12 to 32% by weight. The ethylene/vinyl acetate copolymer preferably has a melt index, measured in accordance with ASTM D 1238 at 190° C., ranging from 0.1 to 1000 g/10 minutes, and especially from 0.3 to 30 g/10 minutes.

Ethylene/vinyl acetate copolymers suitable for use in this invention include those available from DuPont under the Elvax® tradename.

A mixture of two or more different ethylene/vinyl acetate copolymers can be used in the compositions of the present invention in place of a single copolymer as long as the average values for the comonomer content will be within the range indicated above. Particularly useful properties may be obtained when two or more properly selected ethylene/vinyl acetate copolymers are used in blends of the present invention.

Ethylene/Alkyl (Meth)acrylate Copolymers

The composition of this invention may comprise at least one ethylene/alkyl (meth)acrylate copolymer as component (b). The term “(meth)acrylic acid” means methacrylic acid and/or acrylic acid. Likewise, the terms “(meth)acrylate” and “alkyl (meth)acrylate” means esters of methacrylic acid and/or acrylic acid. Ethylene/alkyl (meth)acrylate copolymers include copolymers of ethylene and (meth)alkyl acrylates wherein the alkyl moiety contains from one to six carbon atoms. Examples of alkyl acrylates include methyl acrylate, ethyl acrylate and butyl acrylate. “Ethylene/methyl acrylate” (EMA) means a copolymer of ethylene and methyl acrylate. “Ethylene/ethyl acrylate” (EEA) means a copolymer of ethylene and ethyl acrylate. “Ethylene/butyl acrylate” (EBA) means a copolymer of ethylene and butyl acrylate. Of note are ethylene/butyl acrylate copolymers prepared from i-butyl acrylate comonomers (EiBA) and ethylene/butyl acrylate copolymers prepared from n-butyl acrylate comonomers (EnBA).

The relative amount of the alkyl (meth)acrylate comonomer incorporated into the ethylene/(meth)alkyl acrylate copolymer can, in principle, vary broadly from a few weight percent up to as high as 40 weight percent of the total copolymer or even higher. Similarly, the choice of the alkyl group can, again in principle, vary from a simple methyl group up to a six-carbon atom alkyl group with or without significant branching. The relative amount and choice of the alkyl group present in the alkyl acrylate ester comonomer can be viewed as establishing how and to what degree the resulting ethylene copolymer is to be viewed as a polar polymeric constituent in the composition.

Preferably, the alkyl group in the alkyl acrylate comonomer has from one to four carbon atoms and the alkyl acrylate comonomer has a concentration range of from 6 to 40 weight percent of the ethylene/alkyl acrylate copolymer, preferably from 12 to 32 weight %.

Ethylene/alkyl (meth)acrylate copolymers can be prepared by processes well known in the polymer art using either autoclave or tubular reactors. The copolymerization can be run as a continuous process in an autoclave: ethylene, the alkyl (meth)acrylate, and optionally a solvent such as methanol (see U.S. Pat. No. 5,028,674) are fed continuously into a stirred autoclave such as the type disclosed in U.S. Pat. No. 2,897,183, together with an initiator, the disclosures of which are incorporated herein by reference and the description of which is omitted herein for the interest of brevity. In some cases, it may be desirable to use a telogen such as propane, to control the molecular weight. The reaction mixture is continuously removed from the autoclave. After the reaction mixture leaves the reaction vessel, the copolymer is separated from the unreacted monomers and solvent (if solvent was used) by means such as vaporizing the nonpolymerized materials and solvent under reduced pressure and at an elevated temperature.

Tubular reactor produced ethylene/alkyl (meth)acrylate copolymer can be distinguished from the autoclave produced ethylene/alkyl (meth)acrylate as known in the art. The term or phrase “tubular reactor produced” ethylene/alkyl (meth)acrylate copolymer denotes an ethylene copolymer produced at high pressure and elevated temperature in a tubular reactor or the like, wherein the inherent consequences of dissimilar reaction kinetics for the respective ethylene and alkyl (meth)acrylate comonomers is alleviated or partially compensated by the intentional introduction of the monomers along the reaction flow path within the tubular reactor. Such a tubular reactor copolymerization produces a copolymer having a greater relative degree of heterogeneity along the polymer backbone (a more blocky distribution of comonomers), tends to reduce the presence of long chain branching, and produces a copolymer characterized by a higher melting point than one produced at the same comonomer ratio in a high pressure stirred autoclave reactor. Tubular reactor produced ethylene/alkyl (meth)acrylate copolymers are stiffer and more elastic than autoclave produced ethylene/alkyl (meth)acrylate copolymers.

The actual manufacturing of the tubular reactor ethylene/alkyl (meth)acrylate copolymers are well known and the description thereof is omitted herein for the interest of brevity. See, e.g., U.S. Pat. Nos. 3,350,372; 3,756,996; and 5,532,066. See also Richard T. Chou, Mimi Y. Keating and Lester J. Hughes, “High Flexibility EMA made from High Pressure Tubular Process”, Annual Technical Conference—Society of Plastics Engineers (2002), 60^{th}(Vol. 2), 1832-1836.

The ethylene/alkyl acrylate copolymers can vary in melt index numerically in terms of a fraction (e.g., 0.1, 0.2, or 0.4) up to about 10. The specific selection of the grade of ethylene/alkyl acrylate copolymer component(s) to be used will be influenced by balancing factors such viscosities, melt indices or melt flow rates, and melting points of the copolymer and the polypropylene.

Of note are an EMA having 24 weight % of methyl acrylate and a MI of 2 g/10 min and an EMA having 20 weight % of methyl acrylate and a MI of 8 g/10 min.

In a preferred embodiment, the ethylene/alkyl acrylate copolymer is of the type that is prepared in a tubular reactor. Tubular reactor produced ethylene/alkyl acrylate copolymers are commercially available from DuPont under the Elvaloy® AC tradename.

A mixture of two or more different ethylene/alkyl (meth)acrylate copolymers can be used in the compositions used in the present invention in place of a single copolymer as long as the average values for the comonomer content will be within the range indicated above. Particularly useful properties may be obtained when two or more properly selected ethylene/alkyl (meth)acrylate copolymers are used in the present invention.

Fillers

The filler-containing polypropylene resin composition of the present invention possesses excellent mechanical and thermal properties. Fillers to be used in the present invention, either inorganic or organic, are not particularly restricted. The fillers may be used either individually or, if desired, in combination. Inorganic fillers include calcium carbonate, talc, clay, silica, diatomaceous earth, alumina, zinc white, magnesium oxide, mica, calcium sulfite, calcium sulfate, calcium silicate, glass powders, glass fibers (including silane-treated glass fibers), asbestos, gypsum fibers, and the like. Of note are glass fibers, particularly wherein the glass fibers comprise about 10 to 40 weight % of the total filled composition. Also of note are talc and/or mica.

If desired, the inorganic filler to be used in the present invention can be subjected to surface treatment to ensure a good balance between rigidity and impact strength. Examples of surface treatment agents include organosilane compounds such as vinyltriethoxysilane, vinyltris(β-methoxyethoxy)silane, γ-glycidoxymethoxysilane, γ-methacryloxypropyltrimethoxysilane, γ-aminopropyltriethoxysilane, γ-aminopropyltrimethoxysilane, N-(β-aminoethyl)-γ-aminopropyltrimethoxysilane, N-(β-aminoethyl)-γ-aminopropylmethyl-trimethoxysilane, etc. Of these, N-(β-aminoethyl)-γ-aminopropyltrimethoxysilane and N-(β-aminoethyl)-γ-aminopropylmethyltrimethoxysilane are notable because of their high reactivity.

The surface treatment agent is usually used in an amount of from 0.1 to 1.5 part by weight, and preferably from 0.3 to 1.0 part by weight, per 100 parts by weight of a filler. The surface treatment is preferably performed by the use of a ribbon mixer, a supermixer, etc.

Organic fillers include various cellulosic materials that can be employed in the present invention. Illustrative cellulosic materials can be obtained from, but not limited to, the following sources: wood and wood products, such as wood pulp fibers; non-woody paper-making fibers from cotton; straws and grasses, such as rice and esparto; canes and reeds, such as bagasse; bamboos; stalks with bast fibers, such as jute, flax, kenaf, cannabis, linen and ramie; and leaf fibers, such as abaca and sisal; paper or polymer-coated paper including recycled paper and polymer-coated paper. One or more cellulosic materials can be used.

When such organic fillers are used with the modified polypropylene composition to prepare a composite, the filler may be present in from about 30 to about 70 weight % of the total composition.

Elastomers

The compositions of this invention may optionally contain an elastomeric resin that can function as an impact modifier. Polypropylene is characterized by high tensile strength, high stiffness, and high heat deflection temperature under load. However, one major deficiency is its low impact resistance, particularly at low temperatures. Blending of polypropylene with an elastomeric modifier provides a simple way to significantly improve impact strength of the resin.

In this specification, the term “elastomer” and the like refer to a polymer such as a polyolefin or polystyrene having a relatively low level of crystallinity, that is, in being relatively amorphous. Elastomers by definition herein will have a heat of fusion, as measured by differential scanning calorimetry, at 10° C. per minute heating rate, of less than 30 joules/gram.

Elastomers suitable for use in this invention include various styrene-based elastomers, such as a styrene-butadiene random copolymer, a styrene-butadiene block copolymer, and hydrogenated products thereof; various polyolefin elastomers, such as a non-crystalline ethylene-propylene copolymer and an ethylene-propylenedicyclopentadiene copolymer.

In this specification, “styrene” copolymers include copolymers of styrene or α-methylstyrene with unsaturated monomers such as but not limited to ethylene, butene, butadiene, or isoprene. Specific examples include but are not limited to ethylene/styrene random or block copolymers, ethylene/butadiene/styrene random or block copolymers and hydrogenated and partially hydrogenated butadiene/styrene copolymers. Examples of polystyrenic elastomers would include, for example, di-block and tri-block copolymers sold by Shell under the name “Kraton®” or those sold by Firestone under the name “Stereon®”.

A polyolefin elastomer, for example, may be a copolymer of ethylene and an alpha olefin and would include low density metallocene ethylene/butene copolymers sold by ExxonMobil under the name “Exact®” or metallocene ethylene/octene copolymers sold by Dow under the name “Engage®”. Polyolefin elastomers also include ethylene/propylene copolymers sold by ExxonMobil under the name “Vistalon®”, ethylene/alpha olefin copolymer sold by Mitsui under the name “Tafmer®” or ethylene/propylene/norbornadiene copolymers sold by Dow under the name of “Nordel®”. Polyolefin elastomers also include polybutene rubber and polyisobutylene.

At present, ethylene-propylene rubbers (EPRs), ethylene-propylene diene rubbers (EPDMs) ethylene/butadiene random or block copolymers and metallocene ethylene/alpha-olefin copolymers are the most frequently used polypropylene impact modifiers. Other modifiers used include natural rubber, styrene-butadiene styrene block copolymers (SBS) and its hydrogenated analog (SEBS), polyisobutylene (PIB), and very-low-density polyethylene (VLDPE).

Compositions comprising (a), (b) and (e), wherein component (e) may be present in up to about 95% of the total weight of (a), (b) and (e), are used as compositions for preparing modified polypropylene blends. In blends comprising (a), (b), (c) and (e), component (e) may be present in up to about 40% of the total weight of (a), (b), (c) and (e). In filled polypropylene compositions, component (e) may be present in up to about 25% of the total weight of (a), (b), (c), (d) and (e).

In the preparation of the filler-containing polypropylene composition in accordance with the method of the present invention, the components (a) to (e) may be dry-blended and then melt-kneaded all at once. Alternatively, they may be blended sequentially in any order to prepare compositions of this invention. For example, components (a) and (b) and optionally (e) are either dry-blended or melt-blended to provide a modifier composition that is subsequently blended with the polypropylene resin, the filler or both. Components (a), (b), (c) and optionally (e) can be either dry-blended or melt-blended to provide a polymeric composition that is subsequently blended with the filler to provide a filled or reinforced composition. Alternatively, components (a) and (b) and optionally (e) may be mixed with the filler (d) and then blended with the polypropylene resin. Of note are methods and compositions wherein (a) and (b) are blended together prior to mixing with the other components.

Of note are methods and compositions wherein the ratio of (a) to (b) is from about 1:20 to about 20:1, alternatively from about 1:4 to about 4:1, alternatively from about 1:4 to about 1:1. Of particular note are methods and compositions wherein the ratio of (a) to (b) is about 1:4.

Of note are compositions comprising components (a), (b), (c), (d) and optionally (e) wherein the combination of (a) and (b) is present in up to about 5 weight %, alternatively in from about 1 to about 5 weight %, of the total composition of (a), (b), (c), (d) and optionally (e) and wherein component (d) is present in the composition in up to about 70 weight % of the total composition of (a), (b), (c), (d) and optionally (e).

Of note is a composition comprising (a), (b), (c), (d) and (e), wherein the combination of (a) and (b) is present in from 1 to 5 weight %, (d) is present in from 10 to 40 weight %, (e) is present in from 10 to 20 weight %, the remainder being (c).

The compositions of the present invention can comprise additional optional materials, such as additives commonly used in polymeric materials including plasticizers, stabilizers including viscosity stabilizers and hydrolytic stabilizers, antioxidants, ultraviolet ray absorbers, anti-static agents, dyes, pigments or other coloring agents, fire-retardants, lubricants, foaming or blowing agents, processing aids, antiblock agents, release agents, and/or mixtures thereof. These additives may be present in the compositions of this invention in quantities that are generally from 0.01 to 15 weight %, preferably from 0.01 to 10 weight %, so long as they do not detract from the basic and novel characteristics of the composition (the weight percentages of such optional additives are not included in the total weight percentages of the compositions described above). Many such additives may be present in from 0.01 to 5 weight %.

The optional incorporation of such ingredients into the compositions can be carried out by any known process. This incorporation can be carried out, for example, by dry blending, by extruding a mixture of the various constituents, by a masterbatch technique, or the like.

For mixing the components and optional additives, apparatus commonly employed for plastics or rubbers, such as a Banbury mixer, a single-screw extruder, a twin-screw extruder, and a roll mill, can be used.

Articles of this invention comprise compositions of this invention, including preferred, notable and alternative compositions as described herein.

Compositions of the present invention can be formed into shaped articles using known methods such as sheet extrusion, injection molding, compression molding, overmolding, blow molding, or profile extrusion. Optionally, formed articles comprising the composition of the present invention can be further processed. For example, pellets, slugs, rods, ropes, sheets and molded articles of the present invention may be prepared and used for feedstock for subsequent operations, such as thermoforming operations, in which the article is subjected to heat, pressure and/or other mechanical forces to produce shaped articles. Compression molding is an example of further processing.

The compositions of this invention, particularly those comprising inorganic fillers, can be used to produce injection-molded articles having a complicated shape and a small thickness under molding conditions while substantially retaining flowability inherent to filler-containing polypropylene resins. The resin composition does not suffer from great reduction in mechanical characteristics, such as rigidity. In particular, the composition has markedly improved impact strength and tensile strength. Weldlines (a defect of molded products caused by incomplete fusion of two or more flows of molten resins) may be less conspicuous as when using known filler-containing polypropylene resins.

The filler-containing polypropylene resin compositions according to the present invention can be used in fields requiring finishing, such as adhesion, coating, painting, printing and the like. Typical examples of their use include exterior parts of automobiles, e.g., a bumper, a bumper corner, etc.; interior parts of automobiles, e.g., instrument panels, meter cases, glove compartments, console boxes, trim, pillar-posts, etc.; motorcycle parts, e.g., fenders, leg seals, etc.; appliance parts, e.g., lids of a washing machine, bodies of a vacuum cleaner, stand of an electric fan, a frame of a ventilating fan, etc.; and hand tools, e.g., electric drills, power saws, etc. including casings and/or grips.

The following Examples are presented to more fully demonstrate and illustrate various aspects and features of the present invention. As such, they are intended to further illustrate the differences and advantages of the present invention, but are not meant to be unduly limiting.

### EXAMPLES

Materials Used

PP-1: A Polypropylene homopolymer with MFR of 3.4 g/10 min (at 230° C.); sold as 5D98 by Dow Chemical Company.

M-1: A modified PP with 0.5% maleic anhydride graft level, and with MI of 120 g/10 min.

M-2: A modified PP with 1.4% maleic anhydride graft level, and with MI of 450 g/10 min.

EMA-1: An ethylene/methyl acrylate copolymer having 24 weight % of methyl acrylate and a MI of 2 g/10 min.

EMA-2: An ethylene/methyl acrylate copolymer having 20 weight % of methyl acrylate and a MI of 8 g/10 min.

EVA-1: An ethylene/vinyl acetate copolymer having 18 weight % of vinyl acetate and a MI of 8 g/10 min.

GF-1: An E-glass chopped strand, filament diameter 13 μm, fiber length 4.5 mm; sold as 96D by Saint-Gobain Vetrotex International.

GF-2: An E-glass chopped strand, filament diameter 13 μm, fiber length 4.5 mm; sold as 968 by Saint-Gobain Vetrotex International.

AO-1: A phenolic-based antioxidant additive; sold as Irganox® 1010 by Ciba Specialty Chemicals.

General Procedure for Preparing Compositions and Test Samples

The modifiers, compositions of the invention, summarized in Table 1 were prepared by mixing the components on a 25 mm W&P twin-screw extruder, with temperatures set in the range of from 160 to 200° C.; the product was strand cut and dried. MI were determined according to ASTM 1238 at 190° C.

TABLE 1

| | Coupling Agent | | | | | |
|---|---|---|---|---|---|---|
| | CA-1 | CA-2 | CA-3 | CA-4 | CA-5 | CA-6 |
| M-1 (weight %) | — | 20 | — | 20 | 50 | 5 |
| M-2 (weight %) | 20 | — | 20 | — | — | — |
| EMA-1 (weight %) | — | — | 80 | — | — | — |
| EMA-2 (weight %) | 80 | 80 | — | — | 50 | 95 |
| EVA-1 (weight %) | — | — | — | 80 | — | — |
| MI (g/10 min) | 18.7 | 13.1 | 7.8 | 11.3 | 37.0 | 8.5 |

The filled compositions described herein were prepared by mixing the components on a 25 mm (9 Barrel) W&P twin-screw extruder: the polypropylene, modifier/coupling agent and antioxidant were dry-blended and fed together at the feed throat (Barrel 1) of the extruder; the glass fibers were fed into the polymer melt using a side feeder located at Barrel 5; temperatures were set in the range of from 170 to 220° C.; the product was strand-cut and dried. The resulting filled composition was then injection molded on a 180-ton Nissei Injection Molding unit using an ASTM family mold. Melt flow rate was measured at 230° C./2.16 kg according to ASTM D-1238; tensile properties, such as tensile strength and elongation, according to ASTM D-638; and impact properties, such as notched Izod, according to ASTM D-256.

The Examples in Table 2 demonstrate the performance of the blended coupling agents CA-1 and CA-2 in glass fiber filled polypropylene formulations with 15% GF-1, compared with no modifier (C1), a standard high graft modifier (C2) and a composition containing EMA with no graft modifier (C5).

TABLE 2

| | Example | | | | |
|---|---|---|---|---|---|
| | C1 | C2 | 3 | 4 | C5 |
| PP-1 (weight %) | 84.9 | 82.9 | 82.9 | 82.9 | 82.9 |
| M-2 (weight %) | — | 2.0 | — | — | — |
| CA-1 (weight %) | — | — | 2.0 | — | — |
| CA-2 (weight %) | — | — | — | 2.0 | — |
| EMA-2 (weight %) | — | — | — | — | 2.0 |
| AO-1 (weight %) | 0.1 | 0.1 | 0.1 | 0.1 | 0.1 |
| MFR (g/10 min) | 2.0 | 1.9 | 1.8 | 1.9 | 1.9 |
| Anhydride Level | 0 | 0.028 | 0.0056 | 0.002 | 0 |
| (weight %) | | | | | |
| Tensile Strength at | 467.2 | 539.8 | 527.4 | 523.8 | 472.9 |
| Break (lbf) | | | | | |
| Elongation at Break | 3.42 | 4.67 | 5.51 | 5.29 | 3.28 |
| (%) | | | | | |
| Notched Izod (ftlb/in) | 1.03 | 1.81 | 2.04 | 2.07 | 1.21 |

Examples 3 and 4 demonstrate that the blended coupling agents provide performance comparable to that of compositions modified with the high graft modifier (C2) at significantly lower anhydride levels; in general, tensile strength is slightly weaker, but elongation and impact resistance are improved. Use of straight EMA as a modifier (C5) provides no performance improvement.

The Examples in Table 3 demonstrate the performance of the blended coupling agents CA-1 and CA-2 in glass fiber filled polypropylene formulations with 30% GF-2, compared with no modifier (C6) and a standard high graft modifier (C7).

TABLE 3

| | Example | | | |
|---|---|---|---|---|
| | C6 | C7 | 8 | 9 |
| PP-1 (weight %) | 69.9 | 67.9 | 67.9 | 67.9 |
| M-2 (weight %) | — | 2.0 | — | — |
| CA-1 (weight %) | — | — | 2.0 | — |
| CA-2 (weight %) | — | — | — | 2.0 |
| AO-1 (weight %) | 0.1 | 0.1 | 0.1 | 0.1 |
| Anhydride Level (weight %) | 0 | 0.028 | 0.0056 | 0.002 |
| MFR (g/10 min) | 1.4 | 1.6 | 1.5 | 1.6 |
| Tensile Strength at Break (lbf) | 641.4 | 748.2 | 732.3 | 749.8 |
| Elongation at Break (%) | 2.28 | 3.47 | 3.81 | 3.50 |
| Notched Izod (ftlb/in) | 1.44 | 2.55 | 2.86 | 2.67 |

Examples 8 and 9 demonstrate that the blended coupling agents deliver performance comparable to that of compositions modified with the high graft modifier (C7), similar to the results summarized in Table 2.

Of note is a comparison between Examples 3 and 4, and between Examples 8 and 9; the performance of the blended coupling agents using the low/medium graft modifier (Examples 4 and 9) is closely comparable with that of the equivalent blended coupling agent prepared with the high graft modifier (Examples 3 and 8). There is no loss of strength and impact performance, even with the lower anhydride levels of Examples 4 and 9.

In Table 4, Example 10 demonstrates the performance of a blended coupling agent prepared with an EMA copolymer with different weight % acrylate and MI than that used in Example 3. Example 11 demonstrates the performance of a blended coupling agent prepared with an EVA copolymer.

TABLE 4

| | Example | | | |
|---|---|---|---|---|
| | 10 | 11 | 12 | 13 |
| PP-1 (weight %) | 82.9 | 82.9 | 82.9 | 82.9 |
| GF-1 (weight %) | 15.0 | 15.0 | 15.0 | 15.0 |
| CA-3 (weight %) | 2.0 | — | — | — |
| CA-4 (weight %) | — | 2.0 | — | — |
| CA-5 (weight %) | — | — | 2.0 | — |
| CA-6 (weight %) | — | — | — | 2.0 |
| AO-1 (weight %) | 0.1 | 0.1 | 0.1 | 0.1 |
| Anhydride Level (weight %) | 0.0056 | 0.002 | 0.005 | 0.0005 |
| MFR (g/10 min) | 1.8 | 1.9 | 1.9 | 2.0 |
| Tensile Strength at Break (lbf) | 522.5 | 543.9 | 538.0 | 514.2 |
| Elongation at Break (%) | 5.00 | 5.38 | 5.84 | 4.75 |
| Notched Izod (ftlb/in) | 1.86 | 2.13 | 2.10 | 1.77 |

Example 11 provides even better tensile strength and impact properties than a similar composition with an EMA copolymer (Example 4).

Examples 12 and 13, together with Example 4, demonstrate the effect of altering the ratio of EMA to MAH-g-PP in the blended coupling agent. Increasing the ratio of MAH-g-PP to EMA to 1:1 (Example 12) provides tensile strength equivalent to and elongation and impact properties superior to that of Comparative Example C2 with only MAH-g-PP modifier, even with lower anhydride levels. Decreasing the ratio to 1:20 (Example 13) provides less improvement in properties, but the properties are still significantly better than the performance of the nonmodified composition, despite an anhydride level as low as 0.0005 weight %.

A demonstration of the synergistic effect of blends of EMA and MAH-g-PP at various ratios in providing improved properties of filled polypropylene compositions is summarized in Table 5. Samples of a series of compositions having varied amounts of EMA and/or MAH-g-PP were prepared as described above with 2 weight % modifier and 15 weight % GF-1 in PP-1. The modifier was prepared using the indicated weight % of MAH-g-PP (M-1) in EMA (EMA-2). The observed tensile strength at break and impact resistance (notched Izod) of the samples are compared to the values expected assuming that the EMA-2 in the modifier has no effect on the properties of the blend except to function as a diluent, lowering the amount of M-1 present. The expected values are calculated using the following equations, derived from the results observed by preparing compositions with 100% EMA-2 modifier and 100% M-1 modifier (Comparative Examples C5 and C17, respectively), wherein P is the weight % of M-1 in the modifier.
Notched Izod=0.0079P+1.21 (1)
Tensile strength=0.5688P+472.9 (2)

TABLE 5

| | | | Tensile Strength | | Notched Izod | |
|---|---|---|---|---|---|---|
| | % M-1 | Melt Flow | at Break (lbf) | | (ft-lb/in) | |
| Example | in Modifier | Rate (g/10 min) | Observed | Expected | Observed | Expected |
| C5 | 0 | 1.91 | 472.9 | 472.9 | 1.21 | 1.21 |
| 13 | 5 | 1.96 | 514.2 | 475.7 | 1.77 | 1.25 |
| 14 | 20 | 1.68 | 524.5 | 484.3 | 2.14 | 1.37 |
| 12 | 50 | 1.91 | 538.0 | 501.3 | 2.11 | 1.61 |
| 15 | 80 | 1.96 | 546.3 | 518.4 | 1.93 | 1.84 |
| 16 | 95 | 2.03 | 552.7 | 526.9 | 1.95 | 1.96 |
| C17 | 100 | 1.66 | 529.8 | 529.8 | 2.00 | 2.00 |

The results in Table 5 indicate that ratios of M-1 to EMA-2 ranging from about 1:4 to about 1:1 provide the best combination of improved tensile strength and improved impact resistance.

Having thus described and exemplified the invention with a certain degree of particularity, it should be appreciated that the following claims are not to be so limited but are to be afforded a scope commensurate with the wording of each element of the claim and equivalents thereof.

1. A composition comprising a modified polypropylene resin, at least one ethylene copolymer, a polypropylene resin, and optionally at least one elastomeric copolymer wherein the modified polypropylene resin comprises from 0.1 to 3 mol % of repeat units derived from an unsaturated dicarboxylic acid anhydride; the ethylene copolymer comprises repeat units derived from ethylene and an ester including vinyl acetate, alkyl acrylate, alkyl methacrylate, or combinations of two or more hereof; the alkyl moiety has 1 to 6 carbon atoms; and the combination of the modified polypropylene resin and the ethylene copolymer is present up to about 5 weight % and the optional elastomeric copolymer is present up to about 70 weight %, based on the total weight of the composition.

2. The composition of claim 2 wherein the combination of the modified polypropylene resin and the ethylene copolymer is about 1 to 5 weight %, the polypropylene resin is present from 10 to 40 weight % and the optional elastomeric copolymer is present 10 to 20 weight %.

3. The composition of claim 1 wherein the ratio of the modified polypropylene resin to the ethylene copolymer is about 1:20 to about 20:1.

4. The composition of claim 2 further comprising the elastomeric copolymer wherein the ratio of the modified polypropylene resin to the ethylene copolymer is about 1:4 to about 4:1.

5. The composition of claim 4 wherein the ration of the modified polypropylene resin to the ethylene copolymer is about 1:4 to about 1:1.

6. The composition of claim 3 wherein the ethylene copolymer is an ethylene/vinyl acetate copolymer present in the combination of the modified polypropylene resin and the ethylene copolymer from at least 50 weight %; the vinyl acetate unit is present in up to 45 weight percent of the copolymer; and the alkyl group in the alkyl acrylate has from one to four carbon atoms.

7. The composition of claim 5 wherein the ethylene copolymer is an ethylene/vinyl acetate copolymer present in the combination of the modified polypropylene resin and the ethylene copolymer from at least 50 weight %; the vinyl acetate unit is present in 6 to 40 weight % of the copolymer; the alkyl group in the alkyl acrylate has from one to four carbon atoms; and the alkyl acrylate has a concentration range of from 6 to 40 weight % of the ethylene/alkyl acrylate copolymer.

8. The composition of claim 7 wherein the vinyl acetate unit is present from 12 to 32 weight % of the copolymer and the alkyl acrylate has a concentration range of from 12 to 32 weight % of the ethylene/alkyl acrylate copolymer.

9. The composition of claim 8 further comprising a filler including calcium carbonate, talc, clay, silica, diatomaceous earth, alumina, zinc white, magnesium oxide, mica, calcium sulfite, calcium sulfate, calcium silicate, glass powder, glass fiber, silane-treated glass fiber, asbestos, gypsum fiber, or combinations of two or more thereof.

10. The composition of claim 9 wherein the filler includes glass fiber comprise about 10 to 40 weight % of the total composition.

11. The composition of claim 10 wherein the elastomeric copolymer comprises a polyolefin elastomer, styrene-based elastomer, or combinations thereof.

12. The composition of claim 10 wherein the elastomeric copolymer is a non-crystalline ethylene-propylene copolymer, an ethylene-propylenedicyclopentadiene copolymer, a metallocene-produced ethylene/α-olefin copolymer, a styrene-butadiene random copolymer, a styrene-butadiene block copolymer, hydrogenated products thereof, or combinations of two or more thereof.

13. A method comprising mixing a modified polypropylene resin, at least one ethylene copolymer, a polypropylene resin, and optionally at least one elastomeric copolymer under a condition sufficient to produce a filled polypropylene composition wherein the modified polypropylene resin comprises from 0.1 to 3 mol % of repeat units derived from an unsaturated dicarboxylic acid anhydride; and the ethylene copolymer comprises repeat units derived from ethylene and an ester including vinyl acetate, alkyl acrylate, alkyl methacrylate, or combinations of two or more hereof; the alkyl moiety has 1 to 6 carbon atoms.

14. The method of claim 13 wherein the combination of the modified polypropylene resin and the ethylene copolymer is present from about 1 to about 5 weight %, the optional elastomeric copolymer is present from 10 to 40 weight %, and the optional elastomeric copolymer is present 10 to 20 weight; based on the total weight of the composition.

15. The method of claim 13 wherein the mixing is melt blending; the mixing further comprising melt blending the elastomeric copolymer; and the ratio of the modified polypropylene resin to the ethylene copolymer is about 1:20 to about 20:1.

16. The method of claim 14 wherein the mixing is melt blending; the mixing further comprising melt blending the elastomeric copolymer; the elastomeric copolymer comprises a polyolefin elastomer, styrene-based elastomer, or combinations thereof; and the ratio of the modified polypropylene resin to the ethylene copolymer is about 1:4 to about 4:1.

17. The method of claim 16 wherein the ethylene copolymer is an ethylene/vinyl acetate copolymer present in the combination of the modified polypropylene resin and the ethylene copolymer from at least 50 weight %; the vinyl acetate unit is present in 6 to 40 weight % of the copolymer; the alkyl group in the alkyl acrylate has from one to four carbon atoms; and the alkyl acrylate has a concentration range of from 6 to 40 weight % of the ethylene/alkyl acrylate copolymer.

18. The method of claim 17 wherein the vinyl acetate unit is present from 12 to 32 weight % of the copolymer and the alkyl acrylate has a concentration range of from 12 to 32 weight % of the ethylene/alkyl acrylate copolymer.

19. The method of claim 18 further comprising melt blending a filler and the elastomeric copolymer is a non-crystalline ethylene-propylene copolymer, an ethylene-propylenedicyclopentadiene copolymer, a metallocene-produced ethylene/α-olefin copolymer, a styrene-butadiene random copolymer, a styrene-butadiene block copolymer, hydrogenated products thereof, or combinations of two or more thereof.

20. An article comprising a composition wherein the composition is as recited in claim 1 and the article is optionally produced by sheet extrusion, injection molding, compression molding, over molding, blow molding, or profile extrusion.
